(19) United States
(12) Patent Application Publication
(10) Pub. No.: US 2016/0271589 A1
(43) Pub. Date: Sep. 22, 2016

(54) PHOTOCATALYTIC HYDROGEN PRODUCTION FROM WATER, AND PHOTOLYSIS SYSTEM FOR THE SAME

(71) Applicant: SAUDI BASIC INDUSTRIES CORPORATION, Riyadh (SA)

(72) Inventors: Hicham Idriss, Riyadh (SA); Ahmed Wahab Khaja, Riyadh (NL); Taiwo A. Odedairo, Riyadh (SA); Majed Mohammed Mussa, Riyadh (SA)

(21) Appl. No.: 15/029,577

(22) PCT Filed: Oct. 17, 2013
(86) PCT No.: PCT/IB2013/059406

§ 371 Date: Apr. 14, 2016

(51) Int. Cl. B01J 23/52; B01J 35/00; B01J 35/10; C01B 3/04; B01J 37/03; B01J 37/06; B01J 37/08; C01B 3/22; B01J 23/02; B01J 37/02

(52) U.S. Cl. CPC B01J 23/52; B01J 23/02; B01J 35/0006; B01J 35/0013; B01J 35/1014; B01J 35/004; B01J 37/0221; B01J 37/031; B01J 37/06; B01J 37/088; C01B 3/22; C01B 3/042; C01B 2203/0277; C01B 2203/1082; C01B 2203/1064

(57) ABSTRACT

In an embodiment, a photocatalyst for the generation of diatomic hydrogen from a hydrogen containing precursor under the influence of actinic radiation comprises: a semiconductor support of SrTiO₃ and TiO₂, wherein a molar ratio of SrTiO₃ and TiO₂ in the semiconductor support is at least 0.01; and a gold and palladium alloy on said semiconductor support. Included herein are embodiments of a photocatalyst system, methods of making diatomic hydrogen, and methods of making the photocatalyst.

### TECHNICAL FIELD

The present invention relates to a photocatalyst for the generation of diatomic hydrogen and to a method for preparation of such catalysts, and to a photolysis system.

### BACKGROUND

Energy and environmental issues at a global level are important topics and to that extent focus has been on the generation of clean energy for some time. Hydrogen in its diatomic form as an energy carrier has the potential to meet at least in part the global energy needs. As a fuel, hydrogen boasts great versatility from direct use in internal combustion engines, gas turbines or fuel cells for both distributed heat and electricity generation needs. As a reacting component, hydrogen is used in several industrial chemical processes, such as for example the synthesis of methanol, higher hydrocarbons and ammonia.

Unfortunately hydrogen is not naturally available in abundance in its diatomic form (H₂, also referred to as molecular hydrogen or diatomic hydrogen). Rather, due to its high reactivity, hydrogen is more commonly bonded to other elements, for example oxygen and/or carbon, in the form of water and hydrocarbons. The generation of diatomic hydrogen from these compounds is in contention with the laws of thermodynamics and therefore requires additional energy to break these naturally occurring bonds.

When diatomic hydrogen is reacted with oxygen the energy stored within the H—H bond is released while producing water (H₂O) as the end product. This, combined with the energy density of hydrogen of about 122 kiloJoules per gram (kJ/g) gives clear advantages for the use of diatomic hydrogen as a fuel.

At present diatomic hydrogen is produced mainly from fossil fuels, biomass and water. Although the technique of diatomic hydrogen production by steam reforming of natural gas is mature it cannot guarantee long-term strategy for a hydrogen economy because it is neither sustainable nor clean. The diatomic hydrogen production through the electrolysis of water is not an energy efficient process as diatomic hydrogen obtained through this process carries less energy than the energy input that is needed to produce it.

Thus, research has focused on the development of new methods to produce hydrogen from renewable resources. Biomass is considered a renewable energy source because plants store solar energy through photosynthesis processes and can release this energy when subjected to an appropriate chemical process, i.e. biomass burning. In this way, biomass functions as a sort of natural energy reservoir on earth for storing solar energy.

The worldwide availability of solar energy is about 4.3×10²⁰ Joules per hour (J/h), corresponding to a radiant flux density of about 1,000 Watts per square meter (W/m²). About 5% of this solar energy is UV radiation; with a light energy of above 3 electron volts (eV). An advantageous method of storing this solar energy is through the generation of diatomic hydrogen. To that extent solar energy may be used in the photocatalysis of water or biomass products such as bio-ethanol into diatomic hydrogen.

Photocatalysis was first reported by Fujishima and Honda (Electrochemical Photolysis of Water at a Semiconductor Electrode, A. Fujishima and K. Honda, Nature, 1972, 238, 37). Since then numerous photocatalysts have been reported both in patent and scientific literature. One summary of these findings is provided by Kudo and Miseki (Heterogeneous photocatalyst materials for water splitting, A. Kudo, Y. Miseki, Chem. Soc. Rev., 2009, 38, 253-278). Others have reported that TiO₂ is the most photo catalytically active natural semiconductor known and that efficient use of sunlight can be obtained by modifying TiO₂ with noble metals, doping TiO₂ with other ions, coupling with other semiconductors, sensitizing with dyes, and adding sacrificial reagents to the reaction solution (Nadeem et al., The photoreaction of TiO₂ and Au/TiO₂ single crystal and powder with organic adsorbates, Int J. Nanotechnol., Vol. 9, Nos. 1/2, 2012); Photocatalytic hydrogen production from ethanol over Au/TiO₂ anatase and rutile nanoparticles, Effect of Au particle size, M. Murdoch, G. W. N. Waterhouse, M. A. Nadeem, M. A. Keane, R. F. Howe, J. Llorca, H. Idriss, Nature Chemistry, 3, 489-492 (2011); The Photoreaction of TiO₂ and Au/TiO₂ single crystal and powder Surfaces with organic adsorbates. Emphasis on hydrogen production from renewable. K. A. Connelly and H. Idriss, Green Chemistry, 14 (2), 260-280 (2012); Effect of Gold Loading and TiO₂ Support Composition on the Activity of Au/TiO₂ Photocatalysts for H₂ Production from Ethanol-Water Mixtures. V. Jovic, W-T. Chen, M. G. Blackford, H. Idriss, and G. I. N. Waterhouse, J. Catalysis, 305, 307-317 (2013); Photocatalytic H₂ Production from Bioethanol over Au/TiO₂ and Pt/TiO₂ Photocatalysts under UV Irradiation—A Comparative Study. V. Jovic, Z. H. N. Al-Azria, D. Sun-Waterhousea, H. Idriss, G. I. N. Waterhouse, Topics in Catalysis, 56, 1139-1151 (2013); Photonic Band Gap Au/TiO₂ materials as highly active and stable Photocatalysts for Hydrogen production from water. G. I. N. Waterhouse, A. K. Wahab, M. Al-Oufi, V. Jovic, D. Sun-Waterhouse, A. Dalaver, J. Llorca, H. Idriss, Scientific Reports, 3, 2849 (1-5) | DOI: 10.1038/srep02849 (2013)).

A problem related to known photocatalysts is that they will not only actively generate hydrogen, but also actively react hydrogen and oxygen. This has the effect that the water photolysis may be followed by a reverse reaction of hydrogen and oxygen into water so that the overall rate of diatomic hydrogen generation is reduced. For example, when a photocatalyst supporting platinum is suspended in water and the suspension is irradiated with light, the hydrogen and oxygen which are generated through photolysis will mix before they leave the catalyst in the form of separate bubbles. The mixed hydrogen and oxygen may contact and react with the platinum and form water again. Hence only a relatively small amount of hydrogen and oxygen can be obtained.

In order to solve and/or compensate for this problem processes have been proposed for increasing the contact between light and the photocatalyst by dispersing powdery semiconductor photo catalysts in water and shaking the entire reaction apparatus. This shaking requires the use of mechanical energy so that the amount of energy used to generate hydrogen may be higher than the amount of energy that is obtained in the form of diatomic hydrogen.

Another solution that has been proposed is to place a photocatalyst on a water-absorbing material, and dampening the surface by impregnating the water-absorbing material with water, then irradiating the surface with light from above. A problem associated with this solution is that the photocatalyst disperses only on the surface of the water-absorbing material leading to inefficient use of the photocatalyst.

Once proposed solution proposes a photolysis system which comprises a casing into which incident light can enter from the outside and a photolytic layer which is disposed inside the casing; wherein the photolytic layer has a light-transmissive porous material and a photocatalyst supported on the porous material; a water layer containing water in its liquid state is placed below the photolytic layer via a first space; a sealed second space is formed above the photolytic layer in the casing. In the proposed configuration, vapor generated from the water layer is introduced into the photolytic layer via the first space and the vapor is decomposed into hydrogen and oxygen by the photocatalyst, which is excited by the light. A problem associated with this solution is that it requires a relatively complex photolysis system which may be cost ineffective.

The solution proposed in US 2009/0188783 overcomes the aforementioned problems and proposes a photolysis system which comprises a casing into which incident light can enter from the outside and a photolytic layer which is disposed inside the casing; wherein the photolytic layer has a light-transmissive porous material and a photocatalyst supported on the porous material; a water layer containing water in its liquid state is placed below the photolytic layer via a first space; a sealed second space is formed above the photolytic layer in the casing. In the proposed configuration, vapor generated from the water layer is introduced into the photolytic layer via the first space and the vapor is decomposed into hydrogen and oxygen by the photocatalyst, which is excited by the light.

A problem associated with the solution of US 2009/0188783 however is that it requires a relatively complex photolysis system which may be cost ineffective.

Hence, there continues to be a need for a photocatalyst for the generation of diatomic hydrogen from a hydrogen containing precursor that provides a good yield in terms of diatomic hydrogen generation. There is a further need for a photocatalyst for the generation of diatomic hydrogen from a hydrogen containing precursor in its liquid state. Still a further need exists for a photocatalyst for the generation of diatomic hydrogen from hydrogen containing precursors that prevents or at least limits the reverse reaction of hydrogen and oxygen to water during photolysis.

### BRIEF SUMMARY

Disclosed herein are photocatalysts, methods for making and using the same and methods for generating diatomic hydrogen.

A photocatalyst for the generation of diatomic hydrogen from a hydrogen containing precursor under the influence of actinic radiation comprising: a semiconductor support of SrTiO₃ and TiO₂, wherein a molar ratio of SrTiO₃ and TiO₂ in the semiconductor support is at least 0.01; and a gold and palladium alloy on said semiconductor support.

The above described and other features are exemplified by the following detailed description.

### DETAILED DESCRIPTION

Disclosed herein is photocatalytic hydrogen production from water, that combines plasmonic excitation with polymporh synergism. For example, a photocatalyst for the generation of diatomic hydrogen from a hydrogen containing precursor under the influence of actinic radiation comprising a semiconductor support with metal particles comprised of SrTiO₃ and TiO₂ with a gold and palladium alloy thereon and wherein a molar ratio of SrTiO₃ and TiO₂ in the semiconductor support particles is at least 0.01. Optionally, at least part of the alloy particles are covered at least in part with a layer of the semiconductor support.

It was surprisingly discovered that semiconductor support particles comprised of these two materials may have a particulate shape with a high surface area that shows a high activity for hydrogen generation. The present inventors refer to such shape as nano-flakes. Such nano-flakes are less than 25 nanometers (nm), preferably less than 20 nm, more preferably less than 10 nm, most preferably less than 5 nm in their largest dimension. An agglomeration of such nano-flakes is referred to as nano-flowers.

It was further discovered found that when the surface of the noble and/or transition metal is covered at least in part by a layer of the semiconductor support material the diatomic hydrogen generation is increased when compared with similar catalysts wherein the metal is not or to a lesser extent covered by such a layer. Without willing to be bound by theory, it is believed that the photocatalytic conversion of water and/or alcohols into diatomic hydrogen is not strictly sensitive to the surface of the metal as per thermal catalytic reactions, but rather depends more on the bulk structure of the catalyst, including also the semiconductor support. However the coverage of the metal surface by a thin layer of semiconductor support results in a reduced surface area of free alloy particles to which the formed hydrogen and oxygen are exposed, resulting in a lower amount of backward reaction to form water catalyzed by such alloy particles. At the same time the thin layer does not limit the advantageous effect of the metal in combination with the semiconductor support, i.e. the metal maintains its effect on electron-hole recombination. Thus, the presence of a thin layer of semiconductor support on the noble and/or transition metal does not adversely affect, in fact enhances, the generation of diatomic hydrogen. Moreover, hydrogen ions because of their small size can diffuse through the thin oxide layer to the metal particle and becomes reduced to molecular hydrogen while O₂ molecules diffusion (because of their size) will be severely limited at the room temperature reaction.

The layer of semiconductor support material can have a thickness of up to 5 nm (e.g., 1 to 5 nm), preferably 1 to 3 nm, more preferably 1-2 nm. A small layer of semiconductor support enables a higher diatomic hydrogen generation rate. The presence of a semiconductor and/or the respective layer thickness may be determined with several techniques or a combination of several techniques. For example with High Resolution Transmission Electron Microscopy (HRTEM) it is possible to detect if the surface of the alloy particle is covered, and to which extent. This method also allows the layer thickness to be determined. Another method may be X-ray photoelectron spectroscopy. Such electron spectroscopy is sensitive to the upper layer of the material only. When the layer of semiconductor support is approximately more than 2 nm the alloy particle can no longer be detected using this technique and as such this technique may be used to determine if and to which extent the surface of the metal particle is covered. A further known method for detecting if and to which extent alloy is covered by semiconductor support is to measure the hydrogen uptake. The more the surface of the metal is covered, the lower the amount of hydrogen that is absorbed on the metal. The semiconductor support as used in the photocatalyst comprises (and preferably consists of) semiconductor support particles. The skilled person will understand that the smaller the particles the higher the surface area of the photocatalyst will be. Regarding the support surface area on which the alloy particles are dispersed the preferred BET surface area is greater than or equal to 3 square meters per gram (m²/g), preferably greater than or equal to 10 m²/g photocatalyst, more preferably greater than or equal to 30 m²/g of photocatalyst. In an embodiment the BET surface area is 30 to 60 m²/g of photocatalyst. The term “BET surface area” is a standardized measure to indicate the specific surface area of a material which is very well known in the art. Accordingly, the BET surface area as used herein is measured by the standard BET nitrogen test according to ASTM D-3663-03, ASTM International, October 2003.

The semiconductor material for the semiconductor support is in the form or particles. The semiconductor material can have the shape referred to as nano-flakes. An agglomeration of such nano-flakes is referred to as nano-flowers. These nano-flakes may have dimensions in the order of 1 nm to 10 nm, preferably 3 nm to 7 nm in for the minor axis lengths (width and thickness) and 15 nm to 50 nm, preferably 20 nm to 40 nm for the major axis length (length).

The material can comprise TiO₂, SrTiO₃, Sr₂TiO₄, Ti₂O₃, or a combination comprising at least one of the foregoing. For example, the material which is used for the semiconductor support can comprise a mixture of TiO₂ and SrTiO₃, a mixture of TiO₂ and CeO₂, a mixture of SrTiO₃ and CeO₂, a mixture of TiO₂, SrTiO₃ and CeO₂, or a mixture of TiO₂, Ti₂O₃, and SrTiO₃. Preferably the semiconductor support comprises SrTiO₃ and even more preferably the semiconductor support consists of SrTiO₃, Sr₂TiO₄, and TiO₂ Preferably the semiconductor support predominantly consists of these materials, meaning that greater than or equal to 90 wt %, preferably greater than or equal to 95 wt %, more preferably greater than or equal to 99 wt % of the semiconductor support consists of the material, wt % based on the total weight of the semiconductor support. Where the semiconductor support is in the form of particles, the photocatalyst can comprise a mixture of semiconductor support particles.

For the avoidance of doubt it should be understood that the components in the semiconductor support particles comprise a mixture of TiO₂, Sr₂TiO₄, and SrTiO₃; TiO₂ and CeO₂; SrTiO₃ and CeO₂; TiO₂, Sr₂TiO₄, SrTiO₃, and CeO₂ are physically inseparable and should not to be confused with semiconductor supports wherein the components form merely a physical mixture, such as those obtained by merely mixing the components.

SrTiO₃ has an indirect band gap of 3.25 eV and TiO₂ in its rutile form has a direct band gap of 3.0 eV. It is believed that the interface of these two materials once prepared in intimate contact at the atomic scale retards the electron-hole recombination rate and thus enhances the photo-catalytic reaction. The molar ratio of SrTiO₃ and TiO₂ in the semiconductor support particles can be selected such that the semiconductor support has one or more, preferably two bandgaps between 2.8eV and 3.3 eV. The lower the band gap, the higher the number of charge carriers and consequently also the higher the recombination rate of the charge carriers. The combination of SrTiO₃ and TiO₂, in particular in TiO₂ in rutile form, allows the combination of slow electron hole recombination rate and a relatively high number of charge carriers. For example, the molar ratio of SrTiO₃ and TiO₂ in the semiconductor support particles can be 0.05 to 1, preferably 0.1 to 0.5. It is believed that within this range the electronic state of the semiconductor support is enhanced and yields higher diatomic hydrogen generation rates.

The one or more noble and/or transition metal(s) can be on the support. The noble and/or transition metals include platinum, rhodium, gold, ruthenium, palladium, rhenium, or a combination comprising at least one of the foregoing. A palladium and gold alloy is preferred.

The palladium and gold alloy (also referred to as the alloy), is present on the semiconductor support in the form of particles wherein an average major axis direction length of the alloy particles, as determined by transmission electron microscopy, is less than or equal to 5 nm. The skilled person will understand that the alloy particles may not be perfectly spherical or circular in shape. Hence, a major axis length as used herein is to be understood as meaning the maximum axis length of the particle. The average major axis length is a numerical average. The alloy particles in the photocatalyst preferably have a major axis length of less than or equal to 200 nm, preferably less than or equal to 100 nm, more preferably less than or equal to 50 nm, and still more preferably less than or equal to 25 nm.

The composition of the alloy is such that the surface thereof is enriched with gold. The present inventors have found that this effect is obtained over a broad range of palladium and/or gold contents. Embodiments of the gold and palladium alloy may comprise 10-90 wt % palladium and 90-10 wt % gold, or 30-70 wt % palladium and 70-30 wt % gold, or 40-60 wt % palladium and 60-40 wt % gold, the weight percent being based on the weight of the alloy. For reason of availability and hence cost the amount of gold in the gold and palladium alloy may be kept at a minimum while maintaining the benefit of the enriched surface of the alloy.

It is preferred that no materials other than palladium and gold are comprised in the alloy. That said, it is believed that alloy may provide advantageous functionality if some other materials, such as metals are part of the alloy. Such further materials may be copper, silver, nickel, manganese, aluminum, iron, and indium. The gold and palladium alloy comprises at least 90 wt %, preferably greater than or equal to 95 wt %, and more preferably greater than or equal to 99 wt % of palladium and gold, based on the weight of the alloy.

Preferably the composition of the palladium and gold alloy is selected such that it has a Plasmon loss in the range from 500 nanometer (nm) to 600 nm as determined by UV-Vis reflectance absorption. Although the mechanism is not fully understood the present inventors believe that a Plasmon loss in this range enhances the photoreaction.

Desirably, greater than or equal to 90 wt %, preferably greater than or equal to 95 wt %, more preferably greater than or equal to 99 wt % of the gold and palladium in the alloy are present in their non-oxidized state. Non-oxidized means that gold and/or palladium is in its pure metal state hence not bound to any oxidizing material such as oxygen. In the embodiment where the alloy further comprises copper, silver, nickel, manganese, aluminum, iron, and indium, (preferably copper and/or silver), greater than or equal to 90 wt %, or greater than or equal to 95wt %, or greater than or equal to 99 wt % of these materials is preferably in the non-oxidized state. It should be understood that this condition is preferred when the photocatalyst is used for the first time and/or after having been exposed to oxygen for some time between photolysis reactions. When the gold and/or palladium are in an oxidized state their activity is lower. Nevertheless, it has been discovered that, in the embodiment where the gold and/or palladium is in an oxidized state, the activity of the photocatalyst will improve upon its use. A possible reason for this being that the hydrogen which is generated will reduce the gold and/or palladium during the photolysis. In order to increase the initial activity, the photocatalysts may be exposed to reducing conditions prior to being used in photolysis.

The amount of alloy in the photocatalyst is selected to obtain a certain desirable hydrogen generation rate. Preferably the amount of alloy can be 0.1 to 10 wt %, preferably 0.4 to 8 wt %, based on the combined weight of the semiconductor support and the one or more noble and/or transition metals deposited thereon wherein the weight of the noble and/or transition metal is based on its elemental state.

Optionally, greater than or equal to 50%, preferably greater than or equal to 80%, more preferably greater than or equal to 95% of the total amount of alloy particles deposited on the semiconductor support is covered with a layer of the semiconductor support. Ideally the whole surface of the alloy is covered. In other words, it is most preferred that all alloy particles are covered by a layer of semiconductor support, so that hydrogen and/or oxygen that are formed during the photocatalytic decomposition of the hydrogen containing precursor are not able to adsorb onto the surface of an alloy particle.

The better the noble and/or transition metal is covered with the semiconductor support the higher diatomic hydrogen generation. Although Strong Metal Surface Interaction (SMSI) phenomenon is generally regarded as problematic for catalytic activity, it has been relied upon in preparing the present photocatalysts. In the SMSI phenomenon, support oxides, such as TiO₂, may cover at least a part of the surface of for example platinum particles deposited on the support. SMSI may start when such a support is subjected to a temperature of greater than or equal to 300° C. Preferably the temperature however is greater than or equal to 500° C. and more preferably 500° C. to 800° C. Too high temperatures may result in decrease of BET surface area of the support and/or agglomeration of the alloy particles resulting in a less efficient photocatalyst. It has surprisingly been found that in the present case photocatalytic activity is enhanced by the effect. As such the present inventors have found a way to use the SMSI in an advantageous manner. It is noted that although the method relies on the SMSI effect, the present method and photocatalyst is not limited to photocatalysts prepared in this manner and that there may be further routes of arriving at the same or similar photocatalysts.

Depending however on the type of support and type of noble and/or transition metals the conditions for preparation of the photocatalyst may be such that the covering process of the noble and/or transition metal also results in decrease of the surface area of the catalyst. In addition the alloy particles size may be enlarged by the heat treatment. These side-effects may result in lower generation rates for diatomic hydrogen, and therefore the skilled person will understand that there will be a trade-off between preservation of surface area on the one hand and increase in coverage of the noble and/or transition metal with the semiconductor support on the other.

The photocatalyst can be prepared according to a method comprising:
i) preparing and/or providing a semiconductor support with gold and palladium alloy thereon; and
ii) optionally heating the support at a temperature in the range from 300° C. to 800° C. for a period (preferably 1 to 24 hours) sufficient to cover the deposited alloy at least in part with a layer of semiconductor support having a thickness of from 1 to 5 nm.
   Preferably the heating is carried out in an inert or reducing atmosphere. A reducing atmosphere is preferred as this will also result in a reduction gold and/or palladium of the alloy present in an oxidized state.

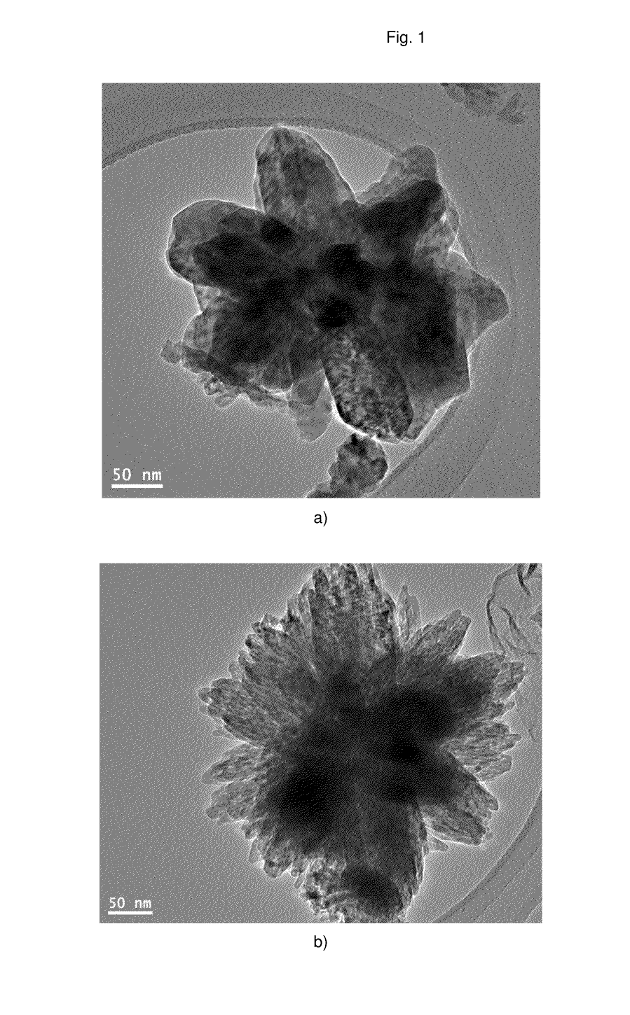

Preparing the semiconductor support with gold and palladium alloy thereon can comprise:
i) combining a titanium precursor, preferably a titanium halogenide and/or titanium alkoxide, and more preferably titanium halogenide and a strontium salt solution, for example, a pH value of below 4, preferably from 1-4;
ii) raising the pH to a value such that precipitation occurs;
iii) washing the precipitate from step ii) with water;
iv) calcining the precipitate; and
v) depositing the gold and palladium alloy onto the support.
   For the avoidance of doubt the sentence “so as to cover at least part of the alloy particles at least in part” means that at least a part of the alloy particles are covered with a layer of semiconductor support. For such alloy particles the layer covers either the entire particle or covers the alloy particle at least in part. This is further explained in FIGS. 1-3.

The deposition may be carried out with a co-impregnation technique wherein gold and palladium are deposited onto the semiconductor support as an alloy. The co-impregnation technique commonly involves three steps. In a first step the semiconductor support is contacted with an impregnating solution comprising the gold and palladium, for example in the form of a soluble salt. In a second step the obtained wet semiconductor particles are dried to remove the liquid and in a third step the photocatalyst is activated by calcination. It was surprisingly found that photocatalysts prepared by co-impregnation of gold and palladium have relatively high activity. It is believed that the co-impregnation method results in a relatively large alloy particle size, which alloy particles, as a result of this alloy particle size, have a considerable Plasmon loss effect. Consequently such alloy particles are more active materials for absorbing sun light in the visible region. In addition to that the alloy particles comprising gold and palladium have a surface which is enriched with gold.

The titanium precursor can be any (water or alcohol) soluble titanium compound and is preferably selected from titanium tetra-alkoxides and titanium halogenides. In that respect a titanium halogenide is defined as a titanium compound wherein at least one halogen atom is bonded to the titanium atom. For example the titanium precursor may be TiCl₄, TiR₄ R₃TiCl, R₂TiCl₂, Cl₃TiR, wherein R is —OCH₃, —OC₂H₅, —OC₃H₇, —OC₄H₉, or —OC(O)CH₃.

If the titanium precursor is a titanium halogenide then the pH in step i) will be low as a result of acid (e.g. HCl) formation. Depending on the amount of titanium halogenide and the amount of halogen atoms per titanium atom in the titanium halogenide however, the addition of additional acid, such as for example HCl, formic acid or acetic acid, to lower the pH to a value of at most 4 and preferably to a value of from 1 to 4 is preferred. If the titanium precursor is not a titanium halogenide the pH in step i) may be lowered to a value of from 1 to 4 by addition of an acid, such as for example HCl, formic acid or acetic acid.

An important feature of the present method is that the support particles are precipitated from a solution comprising the strontium and titanium precursors, as this results in support particles comprise strontium-titanate and titanium-dioxide wherein the strontium-titanate and titanium-dioxide are then obtained in the form of a physically inseparable mixture which allows an efficient atomic contact between these two materials. This efficient atomic contact in turn allows good photocatalytic performance.

Diatomic hydrogen may be generated from a hydrogen containing precursor by contacting the present photocatalyst with the hydrogen containing precursor while exposing the photocatalyst to actinic radiation.

The term hydrogen containing precursor as used herein is to be understood as meaning a compound containing chemically (i.e. covalently or ionically) bonded hydrogen atoms and which compound may successfully be used as a raw material for the photocatalytic generation of diatomic hydrogen. Hydrogen containing compounds that do not result in the photocatalytic generation of diatomic hydrogen are not to be considered as hydrogen containing precursors. For example, alkanes do not generate hydrogen when contacted with the present photocatalyst.

The hydrogen containing precursor as used in the photocatalytic process preferably include water, alcohols, diols and mixtures of at least two of these hydrogen containing precursors. It is particularly preferred to use a mixture of water with one or more alcohols, a mixture of water and one or more diols, or a mixture of water and one or more alcohols and one or more diols. The alcohols and/or diols are water soluble, preferably at room temperature. Hence it is preferred that the hydrogen containing precursor is an aqueous solution of at least one alcohol, an aqueous solution of at least one diol, or an aqueous solution of at least one alcohol and at least one diol.

Preferred alcohols are lower alcohol having from 1-5 carbon atoms and are preferably selected from the group consisting of ethanol, methanol, propanol, isopropanol, butanol and isobutanol. Preferred diols are selected from ethylene glycol, glycerol, and 1,4 butanediol, propylene-1,3-diol, with more preferred glycerol.

For the reason of readily availability it is preferred that the hydrogen containing precursor is a mixture of water and alcohol (preferably ethanol) wherein the amount of alcohol is 0.5 wt % to 95 wt %, preferably 30 wt % to 95 wt %, more preferably 60 wt % to 95 wt % based on the weight of the mixture. Ideally ethanol originating from biomass is used.

The hydrogen containing precursor can be a mixture of water and alcohol wherein the amount of alcohol is from 0.1 to 10% by volume, a mixture of water and diol wherein the amount of diol is from 0.1 to 10% by volume, or a mixture of water, alcohol, and diol wherein the combined amount of alcohol and diol is from 0.1 to 10% by volume based on the mixture. The hydrogen containing precursor can be a mixture of water and glycerol wherein the amount of glycerol is from 0.1 to 10% by volume, or a mixture of water, glycerol, and diol wherein the combined amount of glycerol and diol is from 0.1 to 10% by volume based on the mixture. Preferably the mixture is an aqueous solution. The present inventors believe that the generation of diatomic hydrogen is not limited to water, alcohols and diols, but that other hydrogen containing materials such as for example sugars may also be successfully employed. For example, an aqueous solution of certain sugars may also yield generation of diatomic hydrogen.

The alcohols and/or diols as used in the method according to an embodiment of the present invention act as so called sacrificial agents. Sacrificial agents are compounds that inject electrons into the valence band so as to function as a “hole trap” or “hole scavenger”. This property of the sacrificial agent has the effect that electron—hole recombination is prevented or at least reduced to a minimum and that electrons in the conducting band can be transferred to the gold and palladium alloy, so as to reduce hydrogen ions and to form diatomic hydrogen molecules. Sacrificial agents exist which do not result in the formation of diatomic hydrogen and are therefore not embraced by the term hydrogen containing precursor. In a further embodiment of the present invention the method for generating diatomic hydrogen comprises contacting a photocatalyst according to the present invention with a hydrogen containing precursor in the presence of a sacrificial agent, which is not a hydrogen containing precursor as defined herein, while exposing the photocatalyst to actinic radiation. In such embodiment the combined amount of sacrificial agent and optional diol(s) and alcohol(s) is from 0.1-10% by volume.

Actinic radiation as used herein is to be understood to mean radiation that is capable of bringing about the generation of diatomic hydrogen according to the aforementioned method for generating diatomic hydrogen. To that extent the actinic radiation will have at least a portion in the UV wavelength range being defined herein as from 10 nanometers (nm) to 400 nm. Preferably UV radiation in the range of 300 nm to 400 nm is used. Actinic radiation having a wavelength of less than 300 nm was found to be impractical in the context of the present method. The photonic energy of the actinic radiation is greater than or equal to the band gap energy. The radiant flux density, sometimes referred to as intensity, is preferably 0.3 milliWatts per square centimeter (mW/cm²) to 3.0 mW/cm², more preferably 0.5 mW/cm² to 2.0 mW/cm², e.g., about 1 mW/cm². Depending on season and geographical location this intensity is close to the UV intensity provided by sunlight, meaning that the photocatalytic formation of diatomic hydrogen can be carried out in a sustainable manner if sunlight is used.

Consequently the method for generating diatomic hydrogen from a hydrogen containing precursor preferably comprises contacting the photocatalyst with a hydrogen containing precursor while exposing the photocatalyst to sunlight. Optionally, the sunlight may be concentrated by means of for example lenses so as to obtain the desired radiant flux density. This is in particular relevant for those locations on earth where the intensity from the sun is relatively low.

The photocatalyst may be used in any photolysis system for the generation of diatomic hydrogen from a hydrogen containing precursor. Generally such systems comprise a reaction zone where the actual generation of diatomic hydrogen occurs and one or more separation zones for separating the diatomic hydrogen from other gasses that may be formed or are otherwise present. The systems that may be used includes photolysis systems where the photocatalyst is contacted with the hydrogen containing precursor in its liquid state but also systems where the photocatalyst is contacted with hydrogen containing precursors in its gaseous state, such as for example disclosed in U.S. Pat. No. 7,909,979. A combination system where diatomic hydrogen is formed from hydrogen containing precursors both in the liquid state as in the gaseous state is considered as a possible embodiment of the present invention, which would allow the use of a mixture hydrogen containing precursors having mutually different vapor tensions.

The present invention will now be explained by the following non-limiting examples and figures (also referred to as FIG.).

FIGS. 1a-1d show TEM pictures of photocatalysts according to the present invention.

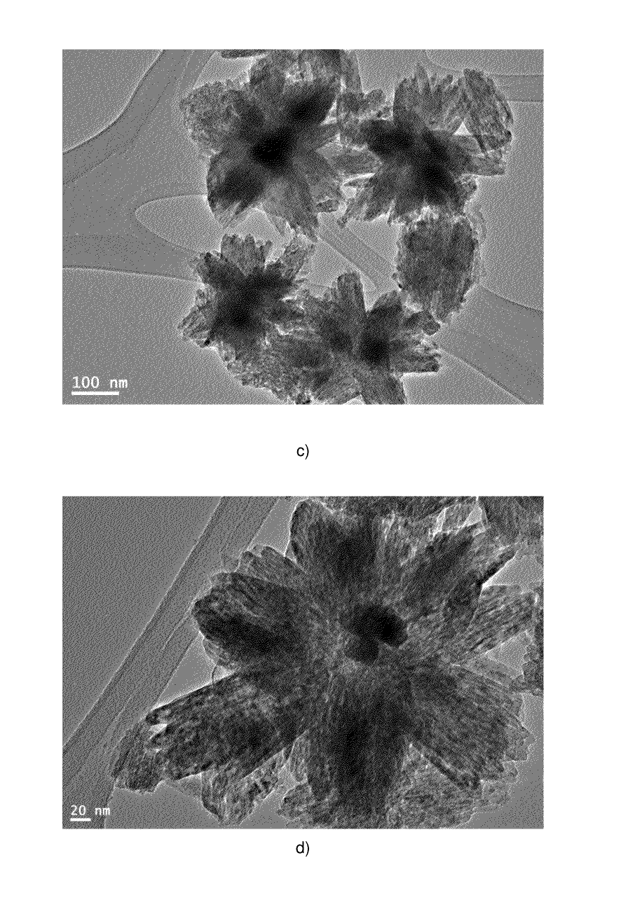

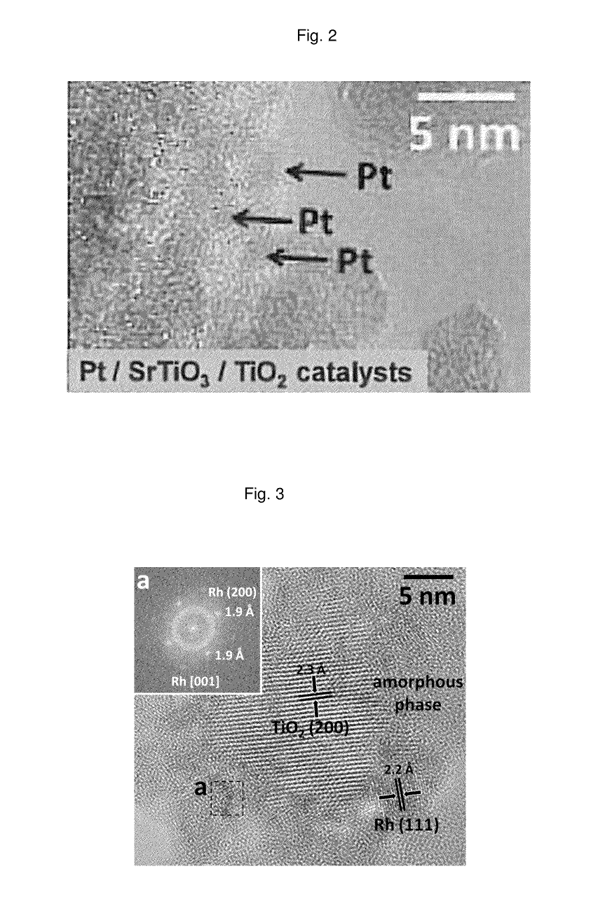

FIG. 2 shows a TEM picture of a photocatalyst according to the present invention.

FIG. 3 shows a further TEM picture of a photocatalyst according to the present invention.

FIG. 4 is a schematic representation of a photocatalyst according the prior art.

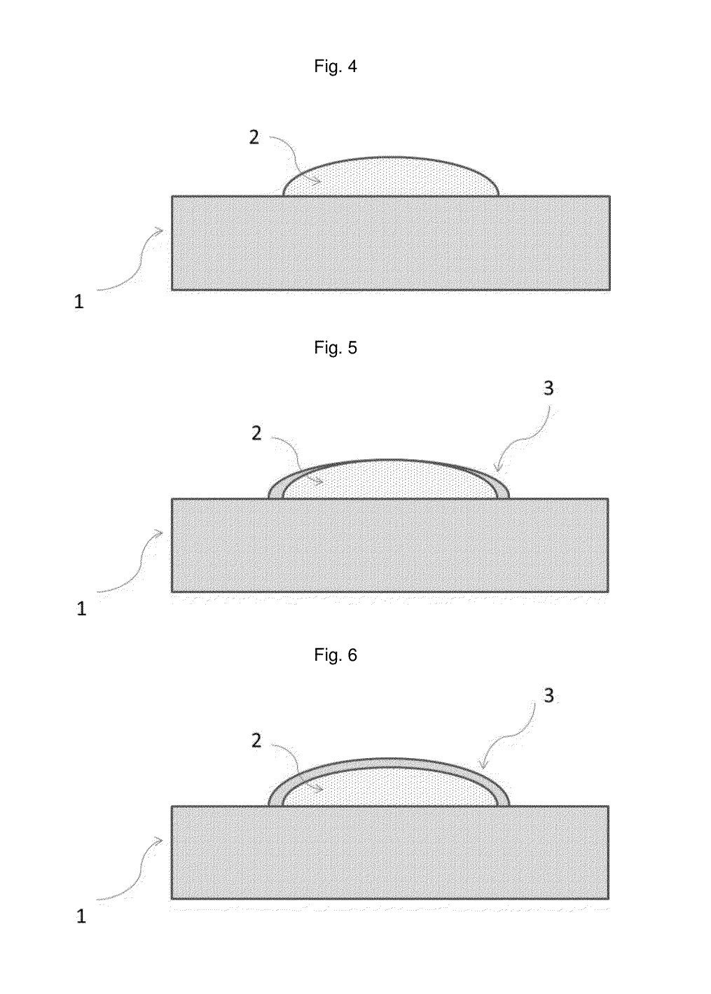

FIG. 5 is a schematic representation of an embodiment of a photocatalyst according to the present invention.

FIG. 6 is a schematic representation of an embodiment of a photocatalyst according to the present invention.

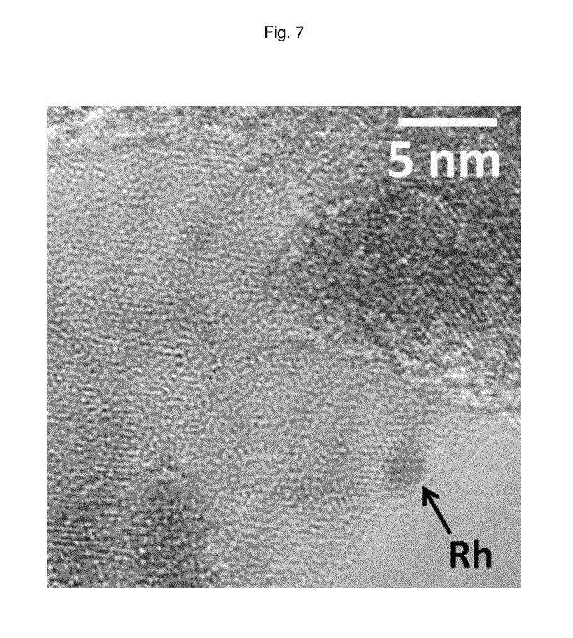

FIG. 7 is a HRTEM photo of a photocatalyst according to the present invention.

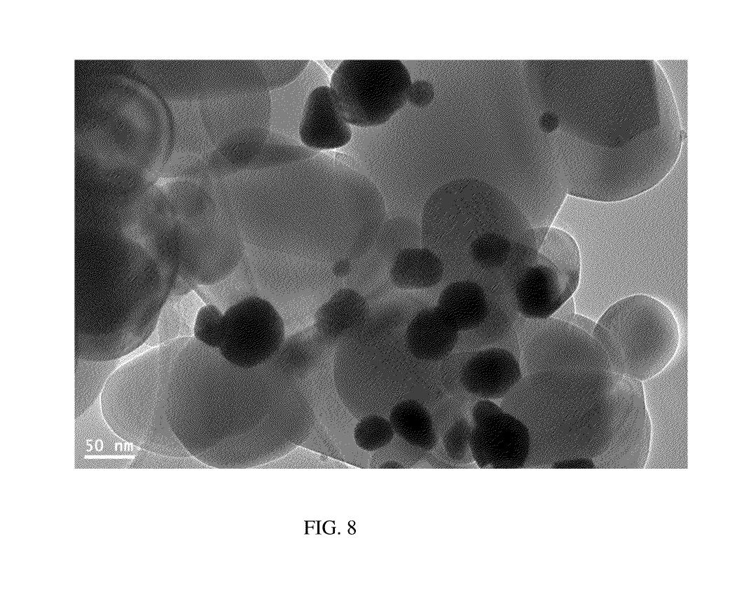

FIG. 8 is a TEM photocatalyst comprising the gold and palladium alloy according to the present invention.

Referring first to FIGS. 1a-1d, these TEM pictures show that the photocatalysts of the invention may be described as nano-flowers or an agglomeration of nano-flakes. The composition of the nano-flakes was shown to contain SrTiO₃ and TiO₂ domains, which already from a size perspective, are physically inseparable. As a result of the small size of the domains there is large area of atomic contact between the two materials allowing for high photocatalytic activity. The metal, in this case rhodium, cannot be distinguished clearly from the support which is indicative for the very small particle size of the metal particles.

The small size of the metal particles is further clear from FIG. 2. The arrows indicate the position of the metal (as determined using TEM) yet no clear particles can be observed.

FIG. 3 is a further TEM picture of a photocatalyst according to the present invention. In this particular catalyst the inventors observed very small rhodium particles, see box “a” in FIG. 3. The rhodium was confirmed by its lattice spacing obtained from its Fourer Transfor image as can be seen in the upper left corner of FIG. 3. For this catalyst the present inventors further distinguished an amorphous phase of TiO₂ and rutile TiO₂.

FIG. 4 schematically shows a photocatalyst according to the prior art and contains a semiconductor support 1 onto which a (noble or transition) metal particle 2 is deposited. As can be clearly seen the surface of metal particle 2 is exposed to its surrounding, so that at the surface of metal particle 2 hydrogen and oxygen, which are formed during the reaction, may be reacted to water.

FIG. 5 schematically shows a photocatalyst according to the present invention and contains a semiconductor support 1 onto which a (noble or transition) metal particle 2 is deposited. As can be seen the surface of metal particle 2 is covered in part with a layer 3 of support material 1. Since metal particle 2 is now partially covered by layer 3, the surface area on metal particle 2 to allow reaction of hydrogen and oxygen, formed during photocatalytic conversion of a hydrogen containing precursor, is reduced so that the overall efficiency of the photocatalyst in terms of hydrogen formation is increased when compared to the photocatalyst of FIG. 4.

FIG. 6 schematically shows a further photocatalyst according to the present invention and contains a semiconductor support 1 onto which a (noble or transition) metal particle 2 is deposited. As can be clearly seen the surface of metal particle 2 is fully covered with a layer 3 of support material 1. Since metal particle 2 is now fully covered by layer 3, there is no surface area on metal particle 2 available to allow reaction of hydrogen and oxygen, formed during photocatalytic conversion of a hydrogen containing precursor, so that the overall efficiency of the photocatalyst in terms of hydrogen formation is increased, or even maximized, when compared to the photocatalyst of FIG. 4.

The skilled person will understand that actual photocatalysts may have a support that contains metal particles as schematically illustrated in FIG. 5 as well as metal particles as schematically illustrated in FIG. 6. It is even possible that actual photocatalysts further include a minor amount of metal particles as illustrated in FIG. 4.

### Catalyst Preparation I

Catalysts were prepared by the sol-gel method. TiCl₄ was added to a strontium-nitrate solution in appropriate amounts to make either strontium titanate (SrTiO₃) or strontium titanate with excess titanium oxide (TiO₂). Approximately thirty minutes after the addition of TiCl₄ to the strontium nitrate solution the pH was raised with sodium hydroxide to a value of between 8 and 9 at which pH value strontium hydroxide and titanium hydroxide precipitated.

The precipitate was left to stand for about 12 hours at room temperature to ensure completion of the reaction after which it was filtered and washed with de-ionized water until neutral pH (˜7). The resulting material was then dried in an oven at 100° C. for a period of at least 12 hours. Next the material was calcined at a temperatures in the range from 500° C. to 800° C. X-ray diffraction techniques were used to indicate formation of SrTiO₃ alone or a mix of SrTiO₃ (perovskite) and TiO₂ (rutile and/or anatase).

The noble and/or transition metals were introduced from their precursors such as RhCl₃/HCl, PtCl₄/H₂O, PdCl₂/HCl, RuCl₃, etc. onto the semiconductor support. The solution was kept at about 60° C. under stirring until a paste formed.

Different preparations were conducted in which the HCl concentration was changed between 0.1 and 1 N. The paste was then dried in an oven at 100° C. for a period of at least 12 hours followed by calcination at a temperature in the range from 350° C. to 800° C.

Bimetals, i.e. a mixture of two noble and/or transition metals, were deposited in a co-impregnation methods whereby both metal precursors were added instead of only one. They were subjected to the same process of the monometallic photocatalysts preparation.

The BET surface area was determined using a surface area analyzer from Quantachrome Corporation.

The following catalysts were made:

TABLE 1

| | Molar ratio | Metal | | |
|---|---|---|---|---|
| | SrTiO₃/TiO₂ | | Concentration | BET |
| | [—] | Type | [wt %] | [m²/g cat.] |
| I (comp.) | TiO₂ only | Pt | 1 | 3 |
| II (comp.) | SrTiO₃ only | Pt | 0.5 | 3.5 |
| III (comp.) | SrTiO₃ only | Rh | 0.5 | 13 |
| IV | 1:10 | Pt | 1 | 43 |
| V | 1:10 | Rh | 1 | 36 |
| VI | 1:10 | Pt | 1 | 11^{a} |
| VII (comp) | SrTiO₃ only | Pt | 1 | 63 |

^{a}Calcined at 800° C.
Comp = comparative example

### Photolysis

Prior to the photolysis the catalysts were reduced with hydrogen at a temperature in the range of 300 to 400° C. for a period of one hour.

Next, 10 to 50 mg of catalyst were introduced into a Pyrex reactor with a total volume of between 100 and 250 milliliters (ml). After purging with nitrogen, 10 to 20 ml of water and/or ethanol were introduced into the reactor. This was followed by further purging with nitrogen to degas the water and/or ethanol solutions.

The reaction was started by exposing the suspension to UV light of intensity between 0.5 and 2 mW/cm². The wavelength of the UV light was about 360 nm.

Extraction of the gas formed was conducted using a syringe. The extracted gas was analyzed using a gas chromatography device equipped with a thermal conductivity detector.

The following diatomic hydrogen gas generation rates were found for the photocatalysts listed in Table 1.

TABLE 2

| | Water | Ethanol | H₂ generation rate |
|---|---|---|---|
| Catalyst | [wt %] | [wt %] | [mol/(gram cat. min)] |
| I (comp) | 0 | 100 | 0.5 × 10⁻⁶ |
| II (comp) | 50 | 50 | 0.25 × 10⁻⁶ |
| III (comp) | 0 | 100 | 0.6 × 10⁻⁶ |
| IV | 0 | 100 | 1.2 × 10⁻⁶ |
| V | 100 | 0 | 0.15 × 10⁻⁶ |
| V | 50 | 50 | 0.6 × 10⁻⁶ |
| VI | 0 | 100 | 1.0 × 10⁻⁶ |
| VII (comp) | 100 | 0 | 0.3 × 10⁻⁶ |

Comp = comparative example

By varying the heating step different catalysts were made as per Table 3.

TABLE 3

| | | | Heating | | | |
|---|---|---|---|---|---|---|
| | Catalyst | BET | conditions | | | |
| | [—] | [m²/g cat.] | [° C.] | [hr] | [mol/g cat · min] | [mol/m² cat min] |
| | | | | | H₂ Generation rate | |
| | | | | | (95 wt % ethanol in water) | |
| I | 1 wt % Pt | 63^{a} | 300 | 5 | 2 × 10⁻⁶ | 3.2 × 10⁻⁸ |
| | SrTiO₃ | | | | | |
| II | 1 wt % Pt | 4^{b} | 500 | 5 | 0.3 × 10⁻⁶ | 7.5 × 10⁻⁸ |
| | SrTiO₃ | | | | | |
| III | 1 wt % Pt | 5^{a} | 800 | 5 | 0.9 × 10⁻⁶ | 18 × 10⁻⁸ |
| | SrTiO₃ | | | | | |
| | | | | | H₂ Generation rate (water) | |
| IV | 3 wt % Au | 86^{a} | 300 | 10 | 1.1 × 10⁻⁶ | 1.2 × 10⁻⁸ |
| | TiO₂ | | | | | |
| V | 3 wt % Au | 86^{c} | 600 | 10 | 1.7 × 10⁻⁶ | 2 × 10⁻⁸ |
| | TiO₂ | | | | | |

^{a}Made with a sol gel method
^{b}Made from SrTiO₃ microcrystals
^{c}Assumed value; the actual BET surface area was not measured; the actual value might be slightly lower because of possible sintering at higher temperatures. This will not affect the rate per mass and will increase the rate per unit area.

FIG. 7 is a High Resolution TEM image of a photo catalyst according to the present invention wherein the support consists of a mixture of SrTiO₃/TiO₂ prepared by a co-precipitation method as per the present invention. After preparation of the support particles rhodium metal particles were deposited on the support particles. In FIG. 7 one of rhodium particles is marked and from FIG. 7 it follows that the rhodium particles are about 2 nm in size. The diffraction spots of the corresponding FT image unambiguously correspond to a rhodium crystallite.

Using an X-ray photoelectron spectroscopy it was established that the metal particles were covered by a layer of support as a result of the heat treatment. A first Rh/SrTiO₃/TiO₂ photocatalyst was calcined to 500° C. and the signal from rhodium particles was measured indicating that at least some of the surface was not covered with a layer of support. Then, the same material was heated to 850° C. and the signal coming from the rhodium particles largely disappeared. Since X-ray photoelectron spectroscopy is sensitive to the upper layer only the present inventors concluded that the layer of semiconductor support material covering the rhodium particle was at least 2 nm in thickness.

### Catalyst Preparation II

Photocatalysts were prepared using the co-impregnation technique, wherein gold and palladium were deposited onto the semiconductor support. Gold was provided in the form of HAuCl₂ and palladium was provided in the form of PdCl₂. Several catalysts were prepared according to this method, details are provided in Table 4 below. The support in all experiments was titanium dioxide, TiO₂.

Comparative catalysts were prepared using a deposition precipitation technique using either HAuCl₂, PdCl₂, or both HAuCl₂ and PdCl₂. The support for these comparative catalysts was titanium dioxide, TiO₂.

### Photolysis II

Prior to the photolysis the catalysts were reduced with hydrogen at a temperature in the range from 300 to 500° C.

Next, 10 to 50 mg of photocatalyst was introduced into a Pyrex reactor with a total volume of between 100 and 250 ml. After purging with nitrogen, 10 to 20 ml of hydrogen containing precursor (see Table 1 below) were introduced into the reactor so as to form a suspension. This was followed by further purging with nitrogen to degas the water and/or ethanol solutions.

The reaction was started by exposing the suspension to sunlight or to UV light having a wavelength of about 360nm and an intensity of about 1 mW/cm². The UV flux from the sun oscillated between 0.1 and 0.4 mW/cm² from 7 am to 4 pm.

Extraction of the gas formed was conducted using a syringe. The extracted gas was analyzed using a gas chromatography device equipped with a thermal conductivity detector.

TABLE 4

| | Photocatalyst | | | |
|---|---|---|---|---|
| | composition | | H₂ rate [mol | |
| ID | Au [wt %] | Pd [wt %] | H₂/g_{Catal}. min] | precursor |
| C1^{a} | 0.5 | 0 | 0.02 × 10⁻⁵ | ethanol |
| C2^{a} | 0 | 1 | 0.04 × 10⁻⁵ | ethanol |
| C3^{a} | 0.5 | 0.5 | 0.6 × 10⁻⁵ | 1.5 vol. % ethylene |
| | | | | glycol in water |
| C4^{a} | 0.5 | 0.5 | 0.5 × 10⁻⁵ | 1.5 vol. % ethylene |
| | | | | glycol in water |
| C5^{a} | 0.5 | 0.5 | 0.5 × 10⁻⁵ | 0.3 vol. % ethanol in |
| | | | | water |
| C6^{a} | 0.5 | 0.5 | 0.3 × 10⁻⁵ | 0.1 vol. % ethanol in |
| | | | | water |
| C7^{a} | 1 | 1 | 0.5 × 10⁻⁵ | 0.15 vol. % methanol in |
| | | | | water |
| C8^{a} | 0.5 | 0.5 | 0.5 × 10⁻⁵ | 0.15 vol. % methanol + |
| | | | | 0.1% ethanol in water |
| C9^{b} | 1 | 1 | 0.1 × 10⁻⁵ | ethanol |

^{a}Co-Impregnation;
^{b}Deposition precipitation from Au after impregnation of Pd on TiO₂.

Photocatalysts C1 and C2 are not according to the present invention as they only contain either gold (Au) or palladium (Pd).

Photocatalyst C9 is not according to the invention because this catalyst was prepared using a deposition precipitation technique that did not result in the formation of a gold and palladium alloy. Co-impregnation results in the desired formation of a gold and palladium alloy.

A TEM photocatalyst according to the present invention is shown in FIG. 8. The small dark spots, some of them indicated with reference numeral 1 are gold and palladium alloy particles whereas the titanium dioxide semiconductor support is visible as the lighter, and somewhat larger particles. Some of the semiconductor support particles are indicated by reference numeral 2.

### Preparation

The support SrTiO₃ was either commercial or synthesized by the sol-gel method. Commercial SrTiO₃ was obtained from Fluka and was composed of micro crystallites of a size of 0.1 to 0.5 micrometer. The method for SrTiO₃ prepared by the sol-gel method was as follow. TiCl₄ was added to a strontium-nitrate solution in stoichiometric amounts to make strontium titanate (SrTiO₃). After the addition of TiCl₄ to the strontium nitrate solution the pH was raised with sodium hydroxide to a value of between 8 and 9 at which pH value strontium hydroxide and titanium hydroxide precipitated. The precipitate was left to stand for about 12 hours at room temperature to ensure completion of the reaction after which it was filtered and washed with de-ionized water until neutral pH (˜7). The resulting material was then dried in an oven at 100° C. for a period of at least 12 hours. Next the material was calcined at 800° C. for 10 to 12 hours. X-ray diffraction techniques were used to confirm the formation of SrTiO₃. The sol gel method produced much smaller crystallites of about 30 nm in size (as measured from TEM).

The noble metals were introduced from their precursors such as PdCl₂/HCl and HAuCl₂/HCl onto the semiconductor support (SrTiO₃) with the equivalent amounts to make 0.5 wt.% Pd and 0.5 wt. % Au. The solution was kept at about 60° C. under stiffing until a paste formed. The paste was then dried in an oven at 100° C. for a period of at least 12 hours followed by calcination at 350° C.

### Photoreaction

Photocatalytic tests were conducted under batch conditions. Catalyst (10 milligrams (mg) to 25 mg) was loaded into a 200 milliliters (mL) Pyrex reactor, water (60 mL) was added to the reactor and variable amounts of ethylene glycol (from 0.1 mL to 10 mL). The liquid-solid was purged with nitrogen (N₂) for about one hour at room temperature prior to reaction to remove residual oxygen in water. A UV lamp (Spectra-line—100W) was used with a cut off filter of 360 nm and above. The UV flux at the front side of the reactor was between about 1-1.2 mW/cm². Catalysts were constantly stirred under UV irradiation to ensure maximum light exposure to all particles. Sampling was conducted approximately every about 30 minutes. Products were analyzed using Gas Chromatographs equipped with thermal conductivity detector (TCD) and Hysep Q packed column at 45° C. and with N₂ as the carrier gas for products separation. Plotting the hydrogen production as a function of time gave a straight line as a typical zero order catalytic reaction and the rate extracted from the linear slope.

BET of the catalyst used to make the runs was about 4 m₂/g.

Set forth below are some embodiments of the photocatalyst and methods disclosed herein.

Embodiment 1: A photocatalyst for the generation of diatomic hydrogen from a hydrogen containing precursor under the influence of actinic radiation comprising: a semiconductor support of SrTiO₃ and TiO₂, wherein a molar ratio of SrTiO₃ and TiO₂ in the semiconductor support is at least 0.01; and a gold and palladium alloy on said semiconductor support.

Embodiment 2: The photocatalyst according to Embodiment 1, wherein the alloy is present on the semiconductor support as particles having an average major axis length of 1-100 nm.

Embodiment 3: The photocatalyst according to any Embodiments 1-2, wherein the alloy comprises 10-90 wt % palladium and from 90-10 wt % gold based on the weight of the alloy.

Embodiment 4: The photocatalyst according to any Embodiments 1-3, wherein the alloy comprises greater than or equal to 90 wt %, preferably greater than or equal to 95 wt %, and more preferably greater than or equal to 99 wt % of palladium and gold, based on the weight of the alloy.

Embodiment 5: The photocatalyst according to any Embodiments 1-4, wherein greater than or equal to 90 wt %, preferably greater than or equal to 95 wt %, more preferably greater than or equal to 99 wt % of the gold and palladium in the alloy are present in their non-oxidized state.

Embodiment 6: The photocatalyst according to any Embodiments 1-5, wherein the alloy further comprises at least one of silver and copper.

Embodiment 7: The photocatalyst according to any of Embodiments 1-6, wherein the molar ratio of SrTiO₃ and TiO₂ is selected such that the semiconductor support has one or more, preferably two bandgaps between 2.8 eV and 3.3 eV.

Embodiment 8: The photocatalyst according to any of Embodiments 1-7, wherein the amount of alloy is 0.1 to 10 wt % based on the total weight of the semiconductor support and the alloy.

Embodiment 9: The photocatalyst according to any of Embodiments 1-8, wherein the photocatalyst has a BET surface area of 30 to 60 m² per gram catalyst using the nitrogen absorption technique.

Embodiment 10: The photocatalyst according to any of Embodiments 1-8, wherein the photocatalyst has a BET surface area of 10 to 50 m² per gram photocatalyst using the nitrogen absorption technique.

Embodiment 11: The photocatalyst according to any of Embodiments 1-7, wherein at least part of the alloy is covered with a layer of the semiconductor support.

Embodiment 12: The photocatalyst according to Embodiment 11, wherein the layer has a thickness of 1 to 5 nm, preferably 1 to 3 nm, more preferably 1 -2 nm.

Embodiment 13: The photocatalyst according to any of Embodiments 1-12, wherein the semiconductor support is a mixture comprising SrTiO₃ and TiO₂ that is physically inseparable.

Embodiment 14: The photocatalyst according to any of claims 1-13, wherein the semiconductor support comprises at least two of TiO₂, Ti₂O₃, Sr₂TiO₄, and SrTiO₃.

Embodiment 15: The photocatalyst according to any of claims 1-14, wherein the semiconductor support consists of at least one of TiO₂, SrTiO₃, Sr₂TiO₄, Ti₂O₃, CeO₂, or a combination comprising at least one of the foregoing.

Embodiment 16: A method for preparing a photocatalyst according to any of Embodiments 1-15 comprising providing a semiconductor support and depositing gold and palladium so that a gold and palladium alloy is formed on the semiconductor support.

Embodiment 17: The method of claim 16, wherein the depositing of the gold and the palladium comprises co-impregnating the semiconductor support with the gold and the palladium.

Embodiment 18: A method for generating diatomic hydrogen from a hydrogen containing precursor, comprising contacting a photocatalyst according to any of Embodiments 1-15 with the hydrogen containing precursor while exposing the photocatalyst to actinic radiation.

Embodiment 19: The method according to Embodiment 18, wherein the actinic radiation has a photonic energy of at least 2.5 eV and a radiant flux density of at least 0.1 mW/cm².

Embodiment 20: The method according to Embodiment 18 or 19, wherein the hydrogen containing precursor is selected from the group consisting of water, diols, alcohols and mixtures of at least two of these hydrogen containing precursors.

Embodiment 21: The method of any of Embodiments 18-20 wherein the hydrogen containing precursor is a mixture of water and alcohol wherein the amount of alcohol is from 0.1 to 10% by volume, a mixture of water and diol wherein the amount of diol is from 0.1 to 10% by volume, or a mixture of water, alcohol, and diol wherein the combined amount of alcohol and diol is from 0.1 to 10% by volume based on the volume of the mixture.

Embodiment 22: The method of any of Embodiments 20-21, wherein the alcohol is selected from the group consisting of ethanol, methanol, propanol, isopropanol, butanol, iso-butanol and mixtures of at least two of these alcohols.

Embodiment 23: The method of one or more of preceding Embodiments 18-20 wherein the hydrogen containing precursor is a mixture of water and glycerol wherein the amount of glycerol is from 0.1 to 10% by volume, or a mixture of water, glycerol, and diol wherein the combined amount of glycerol and diol is from 0.1 to 10% by volume based on the volume of the mixture.

Embodiment 24: The method according to any of Embodiments 21-23 wherein the mixture is an aqueous solution.

Embodiment 25: Photolysis system for the generation of diatomic hydrogen with the method according to Embodiments 18-24 comprising a reaction zone containing a photocatalyst according to any of Embodiments 1-15.

Embodiment 26: Use of a gold and palladium alloy in the form of particles deposited on a semiconductor support as photocatalyst for the generation of diatomic hydrogen from a hydrogen containing precursor under the influence of actinic radiation.

Embodiment 27: A method for preparing a photocatalyst according to any of Embodiments 1-15 comprising:
i) combining a titanium precursor, preferably a titanium halogenide, and a strontium salt solution;
ii) raising the pH to a value such that precipitation occurs;
iii) washing the precipitate from step ii) with water;
iv) calcining the precipitate at a temperature in the range of 500 to 800° C. so as to form the support; and
v) depositing the gold and palladium onto the support.

Embodiment 28: The method of Embodiment 27, wherein step i) further comprises lowering the pH of the mixture obtained by combining said titanium precursor and strontium salt solution to a value of at most 4, preferably from 1-4.

Embodiment 29: The method according to any of Embodiments 27-28 further comprising heating the support at a temperature of 300° C. to 800° C. in an inert or reducing atmosphere for a period from 1 to 24 hours so as to cover the alloy at least in part with a layer of semiconductor support having a thickness of 1 to 5 nm.

Embodiment 30: A method for generating diatomic hydrogen from a hydrogen containing precursor, comprising contacting a photocatalyst according to any Embodiments 1-15 with the hydrogen containing precursor while exposing the photocatalyst to actinic radiation.

Embodiment 31: Photolysis system for the generation of diatomic hydrogen with the method according to Embodiment 31, comprising a reaction zone containing a photocatalyst according to any of Embodiments 1-15.

Embodiment 32: A method for photocatalytic hydrogen production from water, comprising: combining plasmonic excitation with polymorph synergism.

Embodiment 33: The method of Embodiment 32, comprising using the photocatalyst of any of Embodiments 1-15.

We claim:

1. A photocatalyst for the generation of diatomic hydrogen from a hydrogen containing precursor under the influence of actinic radiation comprising:
a semiconductor support of SrTiO₃ and TiO₂, wherein a molar ratio of SrTiO₃ and TiO₂ in the semiconductor support is at least 0.01; and
a gold and palladium alloy on said semiconductor support.

2. The photocatalyst according to claim 1, wherein the alloy is present on the semiconductor support as particles having an average major axis length of 1-100 nm.

3. (canceled)

4. The photocatalyst according to claim 1, wherein the alloy comprises greater than or equal to 90 wt %, of palladium and gold, based on the weight of the alloy.

5. The photocatalyst according to claim 1, wherein greater than or equal to 90 wt %, of the gold and palladium in the alloy are present in their non-oxidized state.

6. The photocatalyst according to claim 1, wherein the alloy further comprises at least one of silver and copper.

7. The photocatalyst according to claim 1, wherein the molar ratio of SrTiO₃ and TiO₂ is selected such that the semiconductor support has one or more, bandgaps between 2.8 eV and 3.3 eV.

8. (canceled)

9. The photocatalyst according to claim 1, wherein the photocatalyst has a BET surface area of 30 to 60 m² per gram catalyst using the nitrogen absorption technique.

10. (canceled)

11. The photocatalyst according to claim 1, wherein at least part of the alloy is covered with a layer of the semiconductor support.

12. The photocatalyst according to claim 1, wherein at least part of the alloy is covered with a layer of the semiconductor support, and wherein the layer has a thickness of 1 to 5 nm.

13. The photocatalyst according to claim 1, wherein the semiconductor support is a mixture comprising SrTiO₃ and TiO₂ that is physically inseparable.

14. A method for preparing a photocatalyst according to claim 1 comprising providing a semiconductor support and depositing gold and palladium so that a gold and palladium alloy is formed on the semiconductor support.

15. A method for generating diatomic hydrogen from a hydrogen containing precursor, comprising contacting a photocatalyst according to claim 1 with the hydrogen containing precursor while exposing the photocatalyst to actinic radiation.

16. The method according to claim 15, wherein the actinic radiation has a photonic energy of at least 2.5 eV and a radiant flux density of at least 0.1 mW/cm².

17. (canceled)

18. The method of claim 15, wherein the hydrogen containing precursor is a mixture of water and alcohol wherein the amount of alcohol is from 0.1 to 10% by volume, a mixture of water and diol wherein the amount of diol is from 0.1 to 10% by volume, or a mixture of water, alcohol, and diol wherein the combined amount of alcohol and diol is from 0.1 to 10% by volume based on the volume of the mixture.

19. (canceled)

20. The method of claim 15, wherein the hydrogen containing precursor is a mixture of water and glycerol wherein the amount of glycerol is from 0.1 to 10% by volume, or a mixture of water, glycerol, and diol wherein the combined amount of glycerol and diol is from 0.1 to 10% by volume based on the volume of the mixture.

21. The method according to claim 18, wherein the mixture is an aqueous solution.

22. (canceled)

23. (canceled)

24. A method for preparing a photocatalyst according to claim 1, comprising:
i) combining a titanium precursor, and a strontium salt solution;
ii) raising the pH to a value such that precipitation occurs;
iii) washing the precipitate from step ii) with water;
iv) calcining the precipitate at a temperature in the range of 500 to 800° C. so as to form the support; and
v) depositing the gold and palladium onto the support.

25. The method of claim 24, wherein step i) further comprises lowering the pH of the mixture obtained by combining said titanium precursor and strontium salt solution to a value of at most 4.

26. The method according to claim 24, further comprising heating the support at a temperature of 300° C. to 800° C. in an inert or reducing atmosphere for a period from 1 to 24 hours so as to cover the alloy at least in part with a layer of semiconductor support having a thickness of 1 to 5 nm.

27. (canceled)

28. (canceled)

29. The method according to claim 24, wherein the titanium precursor comprises a titanium halogenide.
